(19) United States
(12) Patent Application Publication
(10) Pub. No.: US 2003/0088518 A1
(43) Pub. Date: May 8, 2003

(54) Method and system for secure printing of indicia via a web based browser

(75) Inventors: Gregg L. Kirk, Norwalk, CT (US); Aleksandar Bulatovi, Harrison, NY (US)

Correspondence Address: Brian A. Lemn, Pitney Bowes Inc., 35 Waterview Drive, P.O. Box 3000, Shelton, CT, 06484, US

(73) Assignee: Pitney Bowes Incorporated, Stamford, CT

(21) Appl. No.: 10/012,960

(22) Filed: Nov. 5, 2001

(51) Int. Cl. H04K 1/00; H04L 9/00; G06F 17/60

(52) U.S. Cl. 705/62

(57) ABSTRACT

A method and system for securely printing postage indicia using a personal computer and a web based browser are provided. A plug-in is utilized to prevent multiple print requests for postage indicia. The plug-in acts as a surrogate print driver and assumes control of the web browser's printing functions. A user accesses a server, via a web browser operating on a host computer, to design a mail piece. The information is assembled by the server in a specific format and returned to the web browser. Upon reading the specific format, the plug-in is activated to organize the information from the server and send it as a print command to a printer coupled to the host computer. Upon completion of the printing, the web browser is automatically directed to another page and the plug-in function is terminated, thereby preventing the printing from being duplicated.

### FIELD OF THE INVENTION

The invention disclosed herein relates generally to postage metering systems and printing postage indicia using a personal computer, and more particularly to a method and system for securely printing postage indicia using a personal computer and a web based browser.

### BACKGROUND OF THE INVENTION

Since the invention of the postage meter by Arthur H. Pitney, it has evolved from a completely mechanical postage meter to a meter that incorporates extensive use of electronic components. Presently, postage metering systems are recognized as either closed or open system devices. In a closed system device, the system functionality is solely dedicated to metering activity. Examples of closed system metering devices include conventional digital and analog postage meters wherein a dedicated printer is securely coupled to a metering or accounting function. In an open system device, the printer is not dedicated to the metering activity. This frees the system functionality for multiple and diverse uses in addition to the metering activity. Examples of open system metering devices include personal computer (PC) based devices with single/multi-tasking operating systems, multi-user applications and digital printers. An open system metering device includes a non-dedicated printer that is not securely coupled to a secure accounting module.

In a closed system device, since the printer is securely coupled and dedicated to the meter, printing cannot take place without accounting. Such closed systems, however, require the renting of the metering device, as postage meters are prohibited by law from being purchased. This requires the payment of a monthly rent, as well as recurring servicing and replenishing of the meter, which require additional time and expense.

In an open system device, a postal security device (PSD) is connected to a host computer. The PSD electronically accounts for postage and produces a digital signature as proof of postage payment. Indicium printing is accomplished using a non-dedicated printer. Such open systems, however, also require renting of the PSD. This requires the payment of a monthly rent, as well as recurring servicing and replenishing of the PSD, which require additional time and expense.

To avoid the recurring costs of renting and maintaining a hardware device at the user's site, such as a meter or PSD, one type of open metering device, known as a “virtual meter”, was developed. A virtual meter includes a host computer without a postal security device (PSD) coupled thereto. The host computer runs client metering applications, but all PSD functions are performed at a Data Center with which the host computer communicates via a network, such as, for example, a Local Area Network (LAN) or the Internet. The host computer must connect with the Data Center to process transactions such as postage dispensing, meter registration, or meter refills. Transactions are requested by the host computer and sent to the Data Center for remote processing. The transactions are processed centrally at the Data Center and the results are returned to the host computer. Accounting for funds and transaction processing are centralized at the Data Center.

With virtual postage meter systems, however, the host computer must run the client metering applications. This includes specific software designed for creation of the mail piece and printing of the indicia. Accordingly, this specific software had to be installed on the host computer, causing a large memory burden on the host computer. Additionally, each time a new version or update of this software is released, the host computer has to be upgraded to include the new version or update. This requires both the time of performing the upgrade as well as the expense of obtaining the upgrade.

To alleviate some of the problems of the virtual postage metering systems, internet-based software is being developed to allow users to access mail piece preparation software through a web browser. The mail piece preparation software is centrally maintained on a server at the Data Center that users can access via a network, such as, for example, the Internet. Such access can occur utilizing a host computer and a browser, such as, for example, Netscape Navigator or Microsoft Internet Explorer, operating on the host computer. The mail piece is created, including certain information, such as, for example, the return address, recipient address, and indicia evidencing payment of postage, at the server and sent to the host computer via the network. Thus, the host computer need not have any special software installed. Despite improving upon the problems of virtual metering systems, however, some problems still remain. For example, once the generated mail piece and indicia are returned to the host computer, there is no method or system in place to prevent copying of the indicia for multiple printing requests. Accordingly, there is no way to prevent a user from printing an indicia more than once. Dishonest users could, therefore, print the same indicia on multiple mail pieces, thereby defrauding the postal authority.

Thus, there exists a need for a method and system for ensuring that indicia prepared utilizing a host computer and a web based browser is safeguarded against being printed more than once.

### SUMMARY OF THE INVENTION

The present invention alleviates the problems associated with the prior art and provides a method and system for securely printing postage indicia using a personal computer and a web based browser.

In accordance with the present invention, a plug-in is utilized by the user's web browser to prevent multiple print requests for postage indicia. The plug-in acts as a surrogate print driver and assumes control of the web browser's printing functions. A user accesses a server, via a web browser operating on a host computer, to design a mail piece, such as, for example, an envelope or mailing label. Flash technology is utilized to allow the user to create the mail piece online, including, for example, the return address and recipient address, one or more graphic images, and postage indicia. The Flash technology maintains a record of the user's settings, and upon a print command by the user the web browser sends the settings to the server. The information is assembled by the server in a specific format, preferably a specific MIME (Multipurpose Internet Mail Extension) type, and returned to the web browser. Upon reading of the specific MIME type, the web browser activates the plug-in, or, if the plug-in is not currently loaded, automatically downloads the plug-in to the host computer. The plug-in organizes the MIME type information from the server and sends it as a print command to a printer coupled to the host computer. Upon completion of the printing, the web browser is automatically directed to another page and the plug-in function is terminated, thereby preventing the printing from being duplicated.

### DESCRIPTION OF THE DRAWINGS

The above and other objects and advantages of the present invention will be apparent upon consideration of the following detailed description, taken in conjunction with accompanying drawings, in which like reference characters refer to like parts throughout, and in which:

FIG. 1 illustrates in block diagram form a system according to the present invention; and

FIGS. 2A and 2B illustrate in flow diagram form a process of securely printing postage indicia using a personal computer and a web based browser according to the present invention.

### DETAILED DESCRIPTION OF THE PRESENT INVENTION

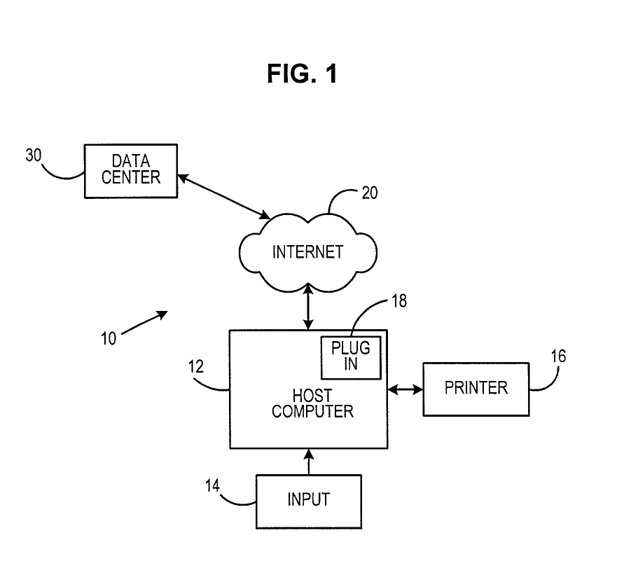

In describing the present invention, reference is made to the drawings, wherein there is seen in FIG. 1 a system 10 for securely printing postage indicia according to the present invention. System 10 includes a remote personal computer, referred to herein as a host computer 12, that has an input device 14 coupled thereto. Input device 14 could be, for example, a keyboard or the like. A printer 16 is also coupled to host computer 12. Printer 16 need not be a dedicated printer, i.e., the printer 16 is not dedicated to the postage metering activity. This frees the functionality of printer 16, along with host computer 12, for multiple and diverse uses in addition to the metering activity.

Host computer 12 is also operatively coupled to a network, such as, for example, the Internet 20. A data center 30 is also coupled to the Internet 20. Data center 30 is preferably operated as a web server that is accessible by host computer 12 via the Internet 20. Host computer 12 includes and executes a standard web browser application, which allows the host computer 12 to access Hypertext Markup Language (HTML) web pages and other data on various web servers, such as data center 30. Such web browsers include, for example, Netscape Navigator and Microsoft Internet Explorer. Host computer 12 therefore provides access to data center 30 for the production of mail pieces as will be further described below.

In accordance with the present invention, host computer 12 is provided with a print control plug-in module 18. Plug-in 18 is utilized to extend the functionality of the web browser to enable the web browser to be used for print control of indicia prepared by data center 30 and sent to host computer 12 for printing on printer 16. It should be noted that unlike dedicated client metering software as previously described, plug-in 18 is not resident at host computer 12 and is only activated upon detection of certain data types as will be described further below.

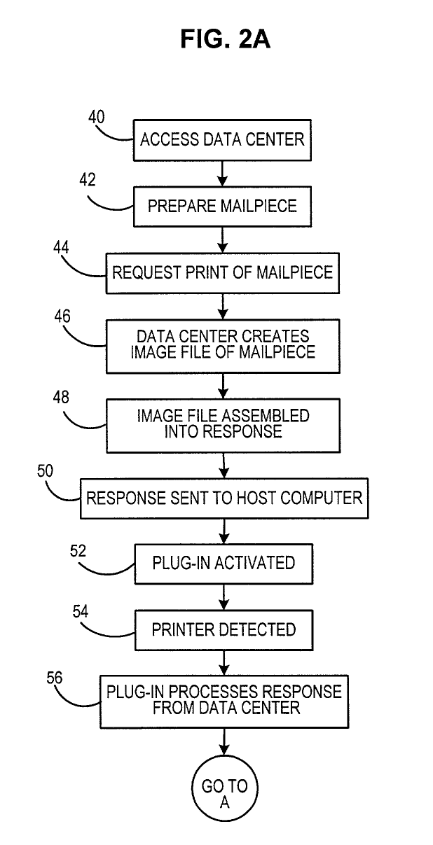

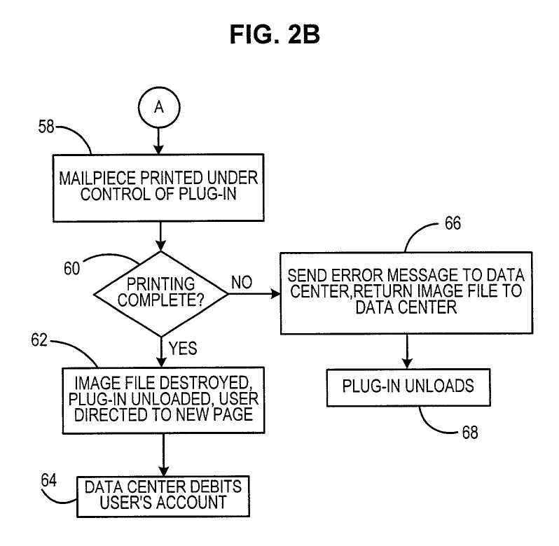

The operation of the system 10 will be described with respect to the process flow diagram illustrated in FIGS. 2A and 2B. In step 40, a user accesses the data center 30 via the Internet utilizing the host computer 12 and a standard web browser. Accessing of data center 30 may include authorization of the user, especially if charges are to be debited or credited to an account for the user that is maintained by data center 30. Such authorization could include, for example, a request for and verification of a user identification and password. Alternatively, user authorization need not be performed if accounting is performed via an on-line payment system, such as, for example, by credit card, debit card or the like.

In step 42, the user prepares a mailpiece for delivery by providing information related to the mailpiece, such as, for example, by inputting the information via input device 14. Alternatively, some or all of the information could be retrieved from files stored in host computer 12 or from a storage medium coupled to host computer 12. Preferably, the mailpiece is prepared utilizing Flash technology, thereby enabling the user to drag and drop various images and elements within the browser. Such information can include, for example, the return address, recipient address, one or more graphic images, and indicia settings. The indicia settings include information necessary to calculate the necessary amount of postage to mail the mailpiece, such as, for example, the weight of the mailpiece, destination zip code, type of service selected, date, etc. Preferably, the Flash technology is programmed to maintain a record of the user's choices and store them in variables rather than just presenting the image of the mailpiece being created via host computer 12.

Once the user has completed preparation of the mailpiece, then in step 44 the user requests printing of the mailpiece. When the user requests a print, data center 30 will read the information posted from step 42, and in step 46 the data center 30 creates an image file of the mailpiece, including the return and recipient addresses, proper indicia, and any graphic images, if requested. Preferably, the image file is in a bitmap file format.

In step 48, the data center 30 assembles the image file created in step 46 into a response to the print request. Such assembly includes, for example, encoding and compressing the image file. Additionally, according to the present invention, the data center 30 assembles the response as a specific MIME (Multipurpose Internet Mail Extension) type. Use of the specific MIME-type initiates control of printing the file by the plug-in 18 as will be further described below. In step 50, the complete response, including a header indicating the content type of the response is in the specific MIME-type and a streamed file, is sent from data center 30 to the web browser operating on host computer 12 via the Internet 20.

In step 52, the browser operating on host computer 12 will, upon detection of the data including the specific MIME-type sent from data center 30, activate plug-in 18. Data center 30 will then validate the version of the plug-in 18 to ensure it is the most recent version. If plug-in 18 is not the most recent version or if plug-in 18 is not currently installed on host computer 12, the user will be prompted to install the latest version of plug-in 18 from a secure site, without having to leave the web page of origin or restarting the browser or host computer 12. Thus, the user need not take any special actions to receive any updates or new releases of plug-in 18. Once the plug-in 18 has been activated, it will take control of the browser function operating on host computer 12 and of the information, i.e., the response, that was originally sent from data center 30 to the browser operating on host computer 12. Thus, the plug-in 18 according to the present invention will act like a client-server application, i.e., it will communicate directly with the data center 30 using specific protocols specified by the data center 30. Thus, the plug-in 18 is capable of updating its own components, and securing and validating any received data. Additionally, the plug-in 18 according to the present invention utilizes several staging protocols during operation. Such functionality is not provided in conventional plug-ins.

Once the plug-in 18 has been activated and taken control of host computer 12, plug-in 18 will detect the presence of printer 16 and determine the settings of printer 16 in step 54. If printer 16 is a non-standard printer, plug-in 18 will require the user to perform a print-position test to ensure that the image file of the mailpiece, including the return and recipient addresses, proper indicia, and any graphic images, if requested, will be printed in the proper location on the mailpiece. If printer 16 is a standard printer, plug-in 18 will cause a dialog box to be displayed via host computer 12 requesting the user to either select printer 16 or possibly another printer coupled to host computer 12 via a network.

Once the user has selected a printer, such as, for example, printer 16, and the plug-in 18 has performed any print-position tests, if necessary, then in step 56 the plug-in 18 will process the print-request response from the data center 30. Such processing includes, for example, downloading the streamed file, decompressing and decoding the response, validating the data, and organizing the image file for printing. In step 58, the plug-in 18 sends a print command to the print driver for printer 16 (or other selected printer) and printing of the image file is performed, i.e., the mailpiece is printed, complete with addresses, indicia, and any graphic images, if requested.

In step 60, it is determined if printing of the image file is completed. If printing has successfully completed, then in step 62 the image file is destroyed, the plug-in 18 unloads, and the user is directed to a different page, thereby preventing duplication of printing of the image file or copying of the image file. In step 64, data center 30 will complete the transaction for payment of the postage, such as, for example, by debiting the user's account. Accordingly, the user will not be charged unless the printing of the mailpiece has successfully been completed, thereby preventing the user from being charged for indicia that was not properly printed.

If in step 60 it is determined that printing of the image file was interrupted or did not complete for any reason, then in step 66 an error message is sent to the data center 30 along with the image file being returned to data center 30. In step 68, the plug-in 18 unloads from host computer 30, thereby preventing the unauthorized printing of the image file or copying of the image file. Preferably, plug-in 18 will store a record of the aborted transaction in a registry. If the user makes another print request, plug-in 18 will detect that the user has an old transaction saved in the registry, and the plug-in 18 will send a prompt to the user requesting if the user would like to continue with the old transaction or delete the old transaction and start a new one. Thus, if the printing of the mailpiece does not properly complete, the user will not have to repeat the creation of the mailpiece to attempt to print it again.

Thus, according to the present invention, a method and system for securely printing postage indicia using a personal computer and a web based browser are provided.

It should be understood that although the present invention was described with respect to a printing postage indicia, the present invention is not so limited and is applicable to any type of system in which value is downloaded and printed. While a preferred embodiment of the invention has been described and illustrated above, it should be understood that this is exemplary of the invention and is not to be considered as limiting. Additions, deletions, substitutions, and other modifications can be made without departing from the spirit or scope of the present invention. Accordingly, the invention is not to be considered as limited by the foregoing description but is only limited by the scope of the appended claims.

What is claimed is:

1. A method for printing postage comprising the steps of:
preparing a mailpiece, said mailpiece including said postage;
creating an image file of said mailpiece at a data center;
assembling said image file into a predetermined format;
sending said image file in said predetermined format to a remote computer;
activating a plug-in at said remote computer, said activation being triggered based on detection of said predetermined format of said image file;
printing said image file, said printing being controlled by said plug-in;
destroying said image file after completion of printing; and
unloading said plug-in from said remote computer, wherein printing of said image file can only be performed a single time.

2. The method according to claim 1, wherein said step of preparing further comprises:
accessing said data center utilizing a web browser.

3. The method according to claim 2, wherein said step of preparing further comprises:
using Flash technology to prepare said mailpiece.

4. The method according to claim 1, wherein said predetermined format is a Multipurpose Internet Mail Extension format.

5. The method according to claim 1, wherein said step of activating said plug-in further comprises:
downloading said plug-in to said remote computer.

6. A method for printing postage indicia using a personal computer and a web based browser operating on said personal computer, said method comprising the steps of:
accessing a data center via the Internet using said personal computer and said web based browser;
preparing a mailpiece, said mailpiece including said postage indicia, and requesting printing of said mailpiece using a printer coupled to said personal computer;
creating an image file of said mailpiece at said data center;
assembling a response to said print request, said response including said image file, said response having a predetermined format;
sending said response from said data center to said personal computer;
activating a print control plug-in at said personal computer, said activation being triggered by receipt of said response at said personal computer;
printing said image file using said printer, said printing being controlled by said print control plug-in;
destroying said image file after printing;
unloading said print control plug-in; and
directing said web based browser to a different page,
wherein said printing of said image file cannot be duplicated.

7. The method according to claim 6, wherein said step of preparing said mailpiece further comprises:
using Flash technology to prepare said mailpiece.

8. The method according to claim 6, wherein said predetermined format is a Multipurpose Internet Mail Extension format.

9. The method according to claim 6, wherein before said step of printing, said method further comprises:
performing a print-position test.

10. The method according to claim 6, wherein said step of assembling said response further comprises:
encoding said image file.

11. The method according to claim 10, wherein said step of assembling said response further comprises:
compressing said image file.

12. The method according to claim 11, wherein said step of printing further comprises:
decoding and decompressing said image file.

13. The method according to claim 6, wherein if said image file is not completely printed, said method further comprises:
sending an error message from said personal computer to said data center.

14. The method according to claim 6, wherein said mailpiece further includes a graphic image.

15. The method according to claim 6, further comprising:
debiting a user's account for said postage indicia.

16. A system for printing postage comprising:
a data center coupled to a network;
a remote computer coupled to said network, said remote computer communicating with said data center via said network utilizing a web based browser;
a print control plug-in module associated with said remote computer; and
a printer coupled to said remote computer;
wherein a mailpiece image including said postage is created by said data center and sent to said remote computer via said network, said plug-in is activated at said remote computer, said activation being triggered by receipt of said mailpiece image, said mailpiece image is printed by said printer under control of said plug-in, and said mailpiece image is destroyed after printing and said plug-in is unloaded from said remote computer, thereby preventing printing of said mailpiece image more than one time.

17. The system according to claim 16, wherein said network is the Internet.

18. The system according to claim 16, wherein said mailpiece image formatted in a predetermined format before being sent to said remote computer, and said activation of said plug-in is triggered based upon detection of said predetermined format.

19. The system according to claim 18, wherein said predetermined format is a Multipurpose Internet Mail Extension format.

20. The system according to claim 16, wherein said mailpiece is created utilizing Flash technology.

21. The system according to claim 16, wherein after said mailpiece image has been printed, said web based browser is automatically directed to a new web page.

22. The system according to claim 16, wherein if printing of said mailpiece image does not complete, an error message is returned to said data center from said remote computer.

23. A system for preparing and printing value bearing indicia via a network, said system comprising:
a data center coupled to said network, said data center adapted to be accessed by a remote computer via said network, said data center preparing an image of said value bearing indicia in a predetermined format and sending said image to said remote computer via said network, receipt of said image in said predetermined format activating a plug-in at said remote computer, said activated plug-in controlling printing of said image using a printer coupled to said remote computer, said image being destroyed upon completion of printing of said image, and said plug-in is unloaded from said remote computer upon completion of printing of said image,
wherein printing of said image more than one time is prevented.

24. The system according to claim 23, wherein said network is the Internet.

25. The system according to claim 23, wherein said predetermined format is a Multipurpose Internet Mail Extension format.

26. The system according to claim 23, wherein said image is part of a mailpiece.

27. The system according to claim 26, wherein said mailpiece is created utilizing Flash technology.

28. The system according to claim 23, wherein if printing of said image does not complete, an error message is returned to said data center from said remote computer.
